(19) United States
(12) Patent Application Publication
(10) Pub. No.: US 2024/0237752 A1
(43) Pub. Date: Jul. 18, 2024

(54) AEROSOL-GENERATING DEVICE WITH GESTURE CONTROL

(71) Applicant: Philip Morris Products S.A., Neuchatel (CH)

(72) Inventors: Yannick BUTIN, Neuchatel (CH); Jean-Daniel ZANONE, Neuchatel (CH); Michael ZELTSBURG, Naharia (IL); Reuf QERESHNIKU, Lesmo (IT); William POIDVIN, Petit-Lancy (CH)

(73) Assignee: Philip Morris Products S.A., Neuchatel (CH)

(21) Appl. No.: 18/558,639

(22) PCT Filed: May 5, 2022
(86) PCT No.: PCT/EP2022/062144

§ 371 Date: Nov. 2, 2023

(30) Foreign Application Priority Data
May 6, 2021 (EP) 21172557.7

(51) Int. Cl. A24F 40/51; A24F 40/53

(52) U.S. Cl. CPC A24F 40/51; A24F 40/53

(57) ABSTRACT

An aerosol-generating device is provided, including: motion detection circuitry including at least one motion sensor and a motion sensor controller configured to process motion sensor data of the at least one motion sensor into gesture data indicative of a gesture performed on the aerosol-generating device by movement of the aerosol-generating device; and device control circuitry including one or more device processors configured to determine, based on analyzing the gesture data provided by the motion sensor controller of the motion detection circuitry, the gesture performed on the aerosol-generating device and to control the aerosol-generating device to perform at least one device function in response to the determined gesture. An aerosol-generating system including the aerosol-generating device, and a method of operating the aerosol-generating device, are also provided.

The present disclosure generally relates to the field of aerosol-generating devices and systems for use of an aerosol-generating article. In particular, the present disclosure relates to an aerosol-generating device with gesture control and to an aerosol-generating system comprising such aerosol-generating device. The present disclosure further relates to a method of operating an aerosol-generating device or system, to a computer program and to a computer-readable medium.

Aerosol-generating devices are typically designed as handheld devices that can be used by a user for consuming, for instance in one or more usage sessions, aerosol generated by an aerosol-generating article. Usually, aerosol-generating articles comprise an aerosol-generating substrate, for example a substrate containing tobacco material and/or a liquid. For generating the aerosol during use or consumption, for example, heat can be applied or transferred from a heating element or heat source in the aerosol-generating device and/or in the aerosol-generating article to heat at least a portion of the aerosol-generating article and/or aerosol-generating substrate.

Exemplary aerosol-generating articles for use with aerosol-generating devices can comprise an aerosol-forming substrate or aerosol-generating substrate that can be assembled, often with other elements or components, in the form of a stick. Such a stick-shaped aerosol-generating article can be configured in shape and size to be inserted at least partially into the aerosol-generating device, which, for example, can comprise a heating element for heating the aerosol-generating article and/or the aerosol-generating substrate. Other exemplary aerosol-generating articles can comprise a cartridge containing a liquid that can be vaporized during aerosol consumption by the user. The cartridge can be configured in shape and size to be inserted at least partially into the aerosol-generating device. Alternatively, the cartridge may be fixedly mounted to the aerosol-generating device and refilled by inserting liquid into the cartridge. Optionally, at least a part of a heating element may be arranged in the aerosol-generating article.

Typical aerosol-generating devices can further include one or more user interfaces allowing a user to control one or more functions of the aerosol-generating device, such as, for example, turning the device on and off. Further, certain information, for example about a state of the aerosol-generating device, such as a battery level, may be provided to the user via a user interface of the device. Exemplary user interfaces for operating or controlling an aerosol-generating device can include one or more buttons, one or more displays, one or more speakers, one or more control elements, one or more vibrating elements, one or more haptic elements, one or more pressure sensitive means, one or more touch control means, one or more lighting means, and one or more light emitting diodes (LEDs). Depending on the type of user interface, however, operational control of one or more functions of the aerosol-generating device may be limited.

Therefore, it may be desirable to provide for an improved aerosol-generating device, for example, providing enhanced or improved operational control.

This is achieved by the subject matter of the independent claims, wherein further embodiments are incorporated in the dependent claims and following description.

In the following, various aspects as well as embodiments and examples of aspects of the present disclosure are described. Aspects of the present disclosure relate to one or more of an aerosol-generating device, an aerosol-generating system, a method for operating an aerosol-generating device or system, a computer program and a computer-readable medium. It should be noted that any feature, step, function, element, technical effect and/or advantage described hereinabove and hereinbelow with reference to one aspect of the present disclosure, equally applies to any other aspect of the present disclosure.

According to an aspect of the present disclosure, there is provided an aerosol-generating device comprising motion detection circuitry, which motion detection circuitry includes at least one motion sensor and a motion sensor controller configured to process motion sensor data of the at least one motion sensor into gesture data, the gesture data being indicative of a gesture performed on the aerosol-generating device by movement of the aerosol-generating device. The aerosol-generating device further comprises device control circuitry, which includes one or more device processors and which is configured to determine, based on analysing and/or processing the gesture data provided by, generated by, and/or originating from the motion sensor controller of the motion detection circuitry, the gesture performed on the aerosol-generating device and to control the aerosol-generating device to perform at least one device function in response to the determined gesture.

Providing the aerosol-generating device with the motion detection circuitry and device control circuitry for controlling one or more device functions based on detecting a gesture performed on the aerosol-generating device can generally enhance operational control of the aerosol-generating device by adding gesture detection and/or gesture control to the device. For example, the aerosol-generating device may be configured to detect or determine a gesture performed on the aerosol-generating device by a user. Such gesture control may advantageously provide an intuitive way of operating or controlling the aerosol-generating device for the user (also referred to as “the device” hereinafter). Also, an overall functionality and operability of the aerosol-generating device may be enhanced or improved.

As will be further discussed hereinbelow, however, “gestures” detectable by the aerosol-generating device are not limited to movements of the aerosol-generating device caused directly by the user by mechanically moving the aerosol-generating device or mechanically interacting with the aerosol-generating device. Rather, the aerosol-generating device can be configured to detect a movement or motion of the aerosol-generating device, for example relative to ground, as “gesture performed on the aerosol-generating device”, which may be caused by a user of the aerosol-generating device or have any other cause, for example when the device drops from a table without involving of the user. Movements of the device caused indirectly by a user and detectable as gestures performed on the aerosol-generating device may, for example, include carrying the device in a pocket or bag, transporting the device in a means of transportation, such as a car, lifting the device, or dropping the device.

The means for gesture control according to the present disclosure, such as the motion detection circuitry and/or device control circuitry, may be integrated in the device at minimum or even without requiring any modification of the exterior design or appearance of the device. This may even allow retrofitting gesture control to existing devices.

Further, by processing the motion sensor data with the motion sensor controller of the motion detection circuitry into the gesture data and analysing the gesture data with the device control circuitry to control the aerosol-generating device, a processing burden for operational control of the aerosol-generating device can be distributed or shared among the motion detection circuitry and the device control circuitry. Particularly, a computing burden or computing resources may be reduced at the device control circuitry. Consequential thereto, more or additional computing resources can be provided to the device control circuitry to perform other tasks, functions or actions, such as for example monitoring one or more status parameters of the device or controlling temperature of one or more heating elements during use of the device.

Moreover, an overall power or energy consumption of the aerosol-generating device may be reduced, as the motion sensor data may be processed with the motion sensor controller of the motion detection circuitry at reduced energy consumption when compared to processing the motion sensor data with the device control circuitry, as the latter may have a higher energy consumption.

The motion detection circuitry with the at least one motion sensor and the motion sensor controller may be integrated in a single component or part, such as a single chip, smart sensor and/or microelectromechanical system (MEMS). Alternatively or additionally, the motion detection circuitry may be integrated into the aerosol-generating device, for example as an electronic circuitry on a substrate, such as a printed circuit board.

The motion sensor controller of the motion detection circuitry may generally denote or refer to a logic component for data processing. The motion sensor controller may, for example, refer to or include one or more processors, microprocessors or microcontrollers.

The at least one motion sensor of the motion detection circuitry may comprise one or more sensors for detecting a motion, a displacement, a positional change, a velocity, a rotation, a rotational change, an orientation, an orientational change and/or an acceleration of the aerosol-generating device. For example, the motion detection circuitry may include at least one tilt sensor for detecting a tilt of the aerosol-generating device, at least one (single or multi axis) accelerometer for detecting acceleration of the aerosol-generating device parallel to and/or about one or more axes, at least one gyroscope for detecting rotational changes and/or motions of the aerosol-generating device about one or more axes, a pressure sensor or barometer for detecting a variation or change in altitude, for example when lifting the aerosol-generating device or climbing stairs, and/or at least one position sensor, such as a global positioning sensor (GPS), for detecting a geographical position of the aerosol-generating device and/or a change in geographical position. It is emphasized that one or more of such sensors or sensor types can be combined in the at least one motion sensor or motion detection circuitry.

In particular, the motion sensor may include an accelerometer-gyroscope sensor combination, which may allow to detect a motion, a displacement, a positional change, a velocity, a rotation, a rotational change, an orientation, an orientational change and/or an acceleration of the aerosol-generating device in one or more spatial directions, parallel to one or more axes of the aerosol-generating device and/or around one or more axes of the aerosol-generating device. As used herein, an axis of the aerosol-generating device may refer to a longitudinal axis (also referred to as x-axis or roll axis hereinafter), a lateral axis (also referred to as y-axis or pitch axis) or a vertical axis (also referred to as z-axis, perpendicular axis or yaw axis) of the aerosol-generating device. Different axes of the aerosol-generating device may be orthogonal with respect each other.

The motion sensor may be configured to detect, measure and/or sense a motion, a displacement, a positional change, a velocity, a rotation, a rotational change, an orientation, an orientational change and/or an acceleration of the aerosol-generating device in one or more spatial directions, parallel to one or more axes of the aerosol-generating device and/or around one or more axes of the aerosol-generating device. Alternative or additionally, the motion sensor may be configured to determine motion sensor data indicative of a motion, a displacement, a positional change, a velocity, a rotation, a rotational change, an orientation, an orientational change and/or an acceleration of the aerosol-generating device in one or more spatial directions, parallel to one or more axes of the aerosol-generating device and/or around one or more axes of the aerosol-generating device.

As used herein, the motion sensor data may refer to or denote raw sensor data provided, determined and/or generated by the motion sensor of the motion detection circuitry in response to sensing and/or detecting a motion, positional change, a rotation, orientational change, a rotational change and/or an acceleration of the aerosol-generating device. For example, the motion sensor data may include one or more of positional data, acceleration data, angular rate data and orientation data, for example one to six axes orientation data. The motion sensor may optionally be configured to output or transmit the motion sensor data to the motion sensor controller of the motion detection circuitry for processing.

The motion sensor controller of the motion detection circuitry may be configured to process the motion sensor data or raw sensor data of the motion sensor into the gesture data. Alternatively or additionally, the motion detection circuitry may be configured to process the motion sensor data generated by and/or originating from the at least one motion sensor. Therein, the motion sensor controller may be configured to analyse the motion sensor data to determine, compute, calculate and/or generate the gesture data. For example, the motion sensor controller may be configured to compute the gesture data based on the motion sensor data, to convert the motion sensor data into the gesture data, to extract the gesture data from the motion sensor data and/or to transform the motion sensor data into the gesture data.

By way of example, the motion sensor data provided by the motion sensor and the gesture data provided by the motion sensor controller of the motion detection circuitry or provided by the motion detection circuitry may differ in one or more of a data format, a time scale, a data size, and content. For instance, the motion sensor may be configured to provide time-related motion sensor data on a first time scale, and the motion sensor controller of the motion detection circuitry may be configured to provide time-related gesture data on a second time scale, wherein the second time scale may be larger than the first time scale. Consequential thereto, data size of the gesture data for describing the gesture performed on the aerosol-generating device, for example performed by the user, may be reduced with respect to the motion sensor data.

Generally, converting the motion sensor data into the gesture data may allow to reduce an overall informational content of the motion sensor data, for example based on focusing an informational content of the gesture data to the gesture performed on the aerosol-generating device, for example by the user, and/or based on removing informational content or information non-related (or only indirectly related) to the gesture.

By way of example, the user may perform a certain gesture with the aerosol-generating device by moving the aerosol-generating device into a certain pose or position, by performing one or more taps on a housing of the device, and/or by rotating the device around one or more axes. Such gesture may be detected by the motion sensor as well as other movements or accelerations of the aerosol, such as for example vibrations caused by the user's hands. Accordingly, the motion sensor data may include information related to or directly related to the gesture performed on the aerosol-generating device and information non-related to the gesture or related to other movements of the aerosol-generating device, which may only indirectly relate to the actual gesture performed on the aerosol-generating device.

In an example, the motion detection circuitry may be configured to generate the gesture data based on determining information in the motion sensor data descriptive of the gesture performed on the aerosol-generating device, for example by the user or not involving the user. Alternatively or additionally, the motion detection circuitry may be configured to filter out and/or remove information non-related to the gesture or related to other movements of the aerosol-generating device. Hence, a data size of the gesture data may be reduced with respect to the motion sensor data, while maintaining or preserving the information descriptive of the gesture performed on the aerosol-generating device.

As used herein, a gesture performed on the aerosol-generating device can include a gesture performed by a user with the aerosol-generating device, which can also be referred to as gesture performed by the user directly on the aerosol-generating device, for example by mechanical interaction of the user with the aerosol-generating device. Alternatively or additionally, “a gesture performed on the aerosol-generating device”, as used herein, can include a movement or motion of the aerosol-generating device caused indirectly by a user of the aerosol-generating device or even being non-related to the user. Exemplary gestures performed on the aerosol-generating device, which have may not necessarily be caused by or related to the user, can be a dropping or free-fall of the device as well as vibrations, positional change, acceleration or rotation of the aerosol-generating device due to transporting the aerosol-generating device, or the like. Movements of the device caused indirectly by a user and detectable as gestures performed on the aerosol-generating device may, for example, include carrying the device in a pocket or bag, transporting the device in a means of transportation, such as a car, train or airplane, lifting the device, or dropping the device. Accordingly, the aerosol-generating device can be configured to determine a gesture performed on the aerosol-generating device by the user, directly by the user, indirectly by the user or by other means non-related to the user.

Generally, a gesture performed by the user with or using the aerosol-generating device can refer to or include any movement of the aerosol-generating device that involves a mechanical, physical and/or haptic interaction of the user with the aerosol-generating device. Therein, a gesture may refer to or include one or more gestural interactions of the user and aerosol-generating device. Non-limiting examples of such gestural interactions or movements include moving the aerosol-generating device to a certain pose or position, moving the aerosol-generating device in one or more spatial directions by a certain distance or with a certain velocity, tilting the aerosol-generating device about one or more axes of the aerosol-generating device, rotating the aerosol-generating device about one or more axes of the aerosol-generating device, single or multiple tapping onto the aerosol-generating device, single or multiple tapping onto a housing of the aerosol-generating device, or any other mechanical or physical interaction of the user with the aerosol-generating device. One or more of such gestural interactions or movements can form or constitute a single gesture performed by the user. Accordingly, a gesture may refer to or comprise a single gestural interaction or a sequence of gestural interactions performed by the user. Hence, basic gestures as well as complex gestures can be detected with the aerosol-generating device to trigger one or more device functions. Similarly, gestures performed on the aerosol-generating device by other means, for example gesture indirectly related to the user or non-related to the user, can include one or more gestural interactions or movements of the aerosol-generating device.

The device control circuitry of the aerosol-generating device can be configured to process the gesture data provided or output by the motion detection circuitry in order to detect the gesture and/or at least one gestural interaction of the gesture performed on the aerosol-generating device, for example by the user. The device control circuitry may further be configured to determine one or more device functions associated with the gesture and/or the at least one gestural interaction of the gesture. For this purpose, for example, certain gestures or gestural interactions may be referenced to or associated with certain device functions of the aerosol-generating device, for example based on storing corresponding reference data in a memory or data storage of the aerosol-generating device.

Generally, the one or more device processors of the device control circuitry can refer to one or more logic components for data processing, for example one or more processors, microprocessors or microcontrollers. The device control circuitry may be configured as single component, part or chip. Alternatively, the device control circuitry may be integrated into the aerosol-generating device as an electronic circuitry on a substrate, such as a printed circuit board.

The device control circuitry may further be configured to operationally control the aerosol-generating device, for instance, based on performing, executing and/or triggering one or more device functions in response determining the gesture. For instance, the device control circuitry may be configured to determine the gesture performed on the aerosol-generating device based on analysing the gesture data received from the motion detection circuitry and to trigger one or more device functions associated with the determined gesture. Triggering or performing the at least one device function by the device control circuitry can include controlling or operating one or more components of the aerosol-generating device, such as a user interface, a heating element, a power supply or a communication interface of the aerosol-generating device.

As used herein, a device function controlled, performed and/or executed by the device control circuitry may include one or more of the exemplary functions described hereinbelow. Generally, a device function as used herein may refer to a function other than or comprising more than just processing gesture data provided by the motion detection circuitry.

For example, the device control circuitry may be configured to alter, modify, set, change and/or configure an operational mode of the device, such as an on mode, an off mode, a standby mode or an idle mode. For example, the device control circuitry may be configured to switch the device between modes and/or to configure the device into a certain mode upon detecting the gesture.

Alternatively or additionally, the device control circuitry may be configured to alter a power state of the aerosol-generating device, for example switch the device or a power supply of the device into an on state or an off state. Alternatively or additionally, the device control circuitry may be configured to alter a configuration of the aerosol-generating device, for example based on specifying or setting one or more device parameters.

Alternatively or additionally, the device control circuitry may be configured to alter, configure and/or switch the device into a locked or an unlocked state of the aerosol-generating device. For example, the device control circuitry may be configured to configure the device from a locked state, in which aerosol-generation by the aerosol-generating device may be prohibited, into an unlocked state, in which aerosol-generation may be permitted. Alternatively or additionally, the device control circuitry may be configured to configure the device from the unlocked state into the locked state.

Alternatively or additionally, the device control circuitry may be configured to actuate a user interface of the aerosol-generating device. For instance, the device control circuitry may be configured to transmit one or more control signals to the at least one user interface to operate or actuate the at least one user interface. Alternatively or additionally, the device control circuitry may be configured to control a user interface of the aerosol-generating device to provide or output information to the user, such as information about the aerosol-generating device, for example a battery level of a battery or energy storage of the aerosol-generating device, and/or information related to an aerosol-generating article coupled to the aerosol-generating device, for example information about a filling level or number of usage sessions of the aerosol-generating article. Also other information can be provided on the user interface in response to detecting a gesture, such as a number of usage sessions the aerosol-generating device was used in total or was used with one or more aerosol-generating articles, a usage time, a number of usage sessions since the device was last recharged, a number of usage sessions remaining with the aerosol-generating device, a number of usage sessions remaining with the current battery level, a number of usage sessions remaining with the aerosol-generating article coupled thereto, a number of charge cycles performed or any other information.

Exemplary user interfaces of the aerosol-generating device can include one or more buttons, one or more displays, one or more speakers, one or more control elements, one or more vibrating elements, one or more haptic elements, one or more pressure sensitive means, one or more touch control means, one or more lighting means, and/or one or more light emitting diodes (LEDs).

Alternatively or additionally, the device control circuitry may be configured to control one or more settings of the aerosol-generating device. For instance, one or more settings or device parameters, such as a heating temperature during aerosol consumption, may be defined or set by the device control circuitry. Alternatively or additionally, the device control circuitry may be configured to reset the aerosol-generating device, for example reset the device to factory settings or reset one or more device parameters, such as a number of usage sessions the aerosol-generating device has been used in the past.

Alternatively or additionally, the device control circuitry may be configured to control a heating element of the aerosol-generating device in response to detecting the gesture. Alternatively or additionally, the device control circuitry may be configured to control a heating element of an aerosol-generating article couplable or coupled to the aerosol-generating device to generate aerosol. Alternatively or additionally, the device control circuitry may be configured to control a heating temperature of the aerosol-generating device during aerosol generation.

Alternatively or additionally, a device function may include and/or the device control circuitry may be configured to store log data indicative of one or more gestures and/or one or more gesture events detected at the motion detection circuitry. In an example, log data for one or more predefined gestures and/or predefined gesture events may be stored or recorded by the device control circuitry. Optionally, the device control circuitry may be configured to discard or refrain from storing log data for one or more further predefined gestures and/or one or more further predefined gesture events.

Generally, the motion detection circuitry with its motion sensor may be configured to detect, as gesture performed on the aerosol-generating device, a movement of the aerosol-generating device, a movement of the aerosol-generating device relative to ground, a movement of the device caused (directly or indirectly) by the user, and/or a movement of the device not caused by or non-related to the user. The motion detection circuitry may further be configured to output or generate corresponding motion sensor data or raw sensor data. The motion sensor controller of the motion detection circuitry may process the motion sensor data and generate gesture data containing information about or being descriptive of the gesture performed on the aerosol-generating device. For example, the motion sensor controller may be configured to eliminate, reduce or remove information non-related to the gesture from the motion sensor data, such that the gesture data may primarily or exclusively contain information descriptive of the gesture. The gesture data may then be processed by the device control circuitry to determine the gesture performed on the aerosol-generating device, for example by the user, and to determine, trigger and/or perform one or more device functions associated with the gesture. Such multi-step approach of gesture control allows to distribute the computing burden for the overall control of the aerosol-generating device among the motion detection circuitry and the device control circuitry, potentially releasing computing resources at the device control circuitry, which may be used for performing other tasks. Also, complex gestures, for example including multiple gestural interactions, can be reliably detected in a fast and efficient manner at reduced energy consumption.

The gesture data provided by the motion sensor controller of the motion detection circuitry may include one or more gesture data elements indicative of a predefined gesture event in the gesture performed on the aerosol-generating device, for example by the user. Alternatively or additionally, the gesture data provided by the motion sensor controller of the motion detection circuitry may include one or more gesture data elements indicative of, for indicating and/or for signalling detection of one or more gesture events by the motion detection circuitry. Accordingly, a gesture data element may be configured to signal determination of one or more gesture events by the motion detection circuitry to the device control circuitry.

In an example, the gesture data can include an interrupt signal. Alternatively or additionally, the motion detection circuitry may be configured to output or provide an interrupt signal to the device control circuitry, for example in response to or upon detection of one or more gesture events at the motion detection circuitry. The motion detection circuitry can be configured to inform and/or alert the device control circuitry that one or more gesture events have been detected at the motion detection circuitry based on providing the interrupt signal and/or the gesture data to the device control circuitry. Optionally, the motion detection circuitry can be configured to inform and/or alert the device control circuitry that one or more gesture data elements corresponding to the one or more gesture events may be transmitted to the device control circuitry.

Generally, an interrupt signal may correspond to one or more bits carrying a piece of information that an input is going to be communicated to the device control circuitry or device processor. It can be processed quickly by device control circuitry or device processor and/or wake up the device control circuitry or device processor, for instance if it is in a low-power or sleep mode. In an example, the device control circuitry or processor may enter into a low-power mode or sleep mode and rely on the motion detection circuitry to be waken up whenever a predefined gesture event is detected by the motion detection circuitry. Accordingly, in an example, an interrupt signal transmitted to the device control circuitry can refer to a wake-up signal if the device control circuitry or device processor is in sleep mode, and/or to an input signal if the device control circuitry or device processor is awake indicating that a predefined gesture event has been detected.

For example, each gesture data element or a plurality of gesture data elements may be indicative of the predefined gesture event detected by the motion sensor controller of the motion detection circuitry. For example, a predefined gesture event may be descriptive, representative, indicative of, or associated with one or more (predefined) gestural interactions performed by the user while performing the gesture. Alternatively or additionally, a predefined gesture event may be descriptive, representative, indicative of, or associated with one or more (predefined) gestural interactions, which may be non-related to the user.

In an example, the aerosol-generating device may be configured to detect a free-fall of the device, which may comprise a positional change or acceleration of the device followed by one or more shocks or vibrations when the device hits a surface. Accordingly, a certain positional change or acceleration may be detected as gesture event at the motion detection circuitry, and the one or more shocks or vibrations may be detected at the motion detection circuitry as gesture event. Corresponding gesture data elements may be provided by the motion detection circuitry to the device control circuitry, which may be configured to detect the gesture “free-fall” based on the gesture data elements, for example two gesture data elements, provided by the motion detection circuitry. Alternatively, however, the motion detection circuitry may detect the entire free-fall and signal detection thereof to the device control circuitry by a single gesture data element.

Alternatively or additionally, the motion sensor controller of the motion detection circuitry may be configured to determine or detect at least one predefined gesture event in the gesture performed on the aerosol-generating device based on processing or analysing the motion sensor data. The motion sensor controller of the motion detection circuitry may be configured to signal detection of the at least one predefined gesture event to the device control circuitry based on providing one or more gesture data elements indicative of the at least one predefined gesture event.

For instance, the motion sensor controller of the motion detection circuitry may be configured to detect one or more gestural interactions of the user with the aerosol-generating device, determine whether a predefined gesture event occurred or has been detected and provide one or more gesture data elements indicative or descriptive of the detected gesture event to the device control circuitry for further processing. Based on analysing the one or more gesture data elements, the gesture or overall gesture performed by the user or performed on the aerosol-generating device can be detected by the device control circuitry.

The motion sensor controller of the motion detection circuitry may be configured to determine at least one predefined gesture event in the gesture performed on the aerosol-generating device based on detecting, determining and/or identifying at least one motion pattern associated with the at least one gesture event in the motion sensor data, wherein the motion sensor controller of the motion detection circuitry may be configured to provide at least one gesture data element indicative of the determined at least one gesture event to the device control circuitry, for example for signalling detection of the gesture event at the motion detection circuitry.

For example, one or more gestural interactions of the user with the aerosol-generating device or non-related to the user, which may correspond to the at least one predefined gesture event, may result in motion sensor data including a specific motion pattern reflecting the gesture event. Hence, by identifying a motion pattern associated with a predefined gesture event in the motion sensor data, the predefined gesture event can be reliably detected. Accordingly, the motion pattern as used herein may refer to a predefined motion pattern.

Alternatively or additionally, the motion sensor controller of the motion detection circuitry may further be configured to detect the at least one motion pattern based on comparing at least a part of the motion sensor data to reference motion data. For example, the reference motion data may be stored in a data storage. Alternatively or additionally, the reference motion data may be retrieved from an external data source, for example via a communication interface of the aerosol-generating device. Generally, the reference motion data may be indicative of one or more reference (or predefined) motion patterns associated with one or more predefined gesture events. For example, the reference motion data may include reference motion sensor data or values expectedly observed or determined with the motion sensor when a certain gesture or gestural interaction is performed on the aerosol-generating device.

For identifying different types of gesture events, for example, a plurality of reference motion patterns can be defined or stored in a data storage of the aerosol-generating device and/or retrieved from an external source, wherein each reference motion pattern may be associated with and/or referenced with at least one gesture event. Optionally, multiple reference motion patterns, such as for example a reference motion pattern for a tap and a reference pattern for a rotation, may be used or combined to define a single gesture event, which can then be detected at or by the motion detection circuitry.

Alternatively or additionally, the motion detection circuitry may be configured to detect the motion pattern in the motion sensor data based on machine state detection. In other words, the motion detection circuitry may include machine state detection means, which can also be referred to as a state machine, for machine state detection to detect one or more motion patterns associated with one or more predefined gesture events.

Generally, a machine state may refer to a finite state of the motion detection circuitry, which can be mathematically described and/or used to perform or trigger logic operations. For example, a behavioural model composed of a plurality of finite machine states and one or more transitions between these states can be implemented in the motion detection circuitry to detect one or more motion patterns in the motion sensor data. When a specific motion or gesture is performed, the machine state detection means of the motion detection circuitry may start in a certain start state, transition between one or more states depending on the motion sensor data provided while the gesture is performed, and arrive at a final state once the gesture or a gesture event is completed. Based on the one or more transitions, the start state and/or the final state, the motion, motion pattern, gesture or gesture event can be detected.

For example, a predefined gesture event can refer to or include one or more of the following items, which can also be referred to as exemplary types of gesture events. A predefined gesture event may include a predefined tilt of the aerosol-generating device with respect to one or more spatial directions, a predefined velocity of the aerosol-generating device in one or more spatial directions, a predefined acceleration of the aerosol-generating device in one or more spatial directions, a predefined translational movement of the aerosol-generating device along one or more spatial directions, a predefined acceleration about one or more of a longitudinal axis, a lateral axis, and a vertical axis of the aerosol-generating device, a predefined angular speed about one or more of a longitudinal axis, a lateral axis, and a vertical axis of the aerosol-generating device, a predefined rotational movement about one or more of a longitudinal axis, a lateral axis, and a vertical axis of the aerosol-generating device, a tap, a double-tap, a multi-tap, a shake, a double-shake, a multi-shake, and a predetermined period of inactivity. Accordingly, the motion detection circuitry may be configured to detect a predefined gesture event based on detecting one or more of the aforementioned items or exemplary types of gesture events. It is emphasized that a gesture event can also include a combination of a plurality of (same or different) of the aforementioned items. For example, a gesture event may be defined as predefined rotation followed by a tap, or the like. Alternatively or additionally, a gesture data element may be indicative of or contain information about one or more of the aforementioned items or types of gesture events.

Alternatively or additionally, reference motion data, such as one or more reference motion patterns, and/or one or more reference values for one or more of the aforementioned items or types of gesture events may be stored in a data storage of the aerosol-generating device (and/or retrieved from an external source) in order to define one or more gesture events. Accordingly, one or more gesture events can be predefined or programmed into the aerosol-generating device based on defining corresponding reference motion data for the one or more gesture events. Some or all of the gesture events can be hardcoded or soft-coded into the aerosol-generating device, for example by a manufacturer of the device. Alternatively or additionally, at least some of the gesture events may be configurable, for example by a user of the aerosol-generating device.

In an example, the motion sensor controller of the motion detection circuitry may be configured to determine a sequence or series of a plurality of gesture events, for example consecutive gesture events, in the gesture performed on the aerosol-generating device and provide a sequence or series of gesture data elements to the device control circuitry. Therein, multiple gesture data elements may be transmitted simultaneously or sequentially. Detecting a plurality of gesture events and transmitting corresponding gesture data elements to the device control circuitry to signal their detection can allow to detect complex gestures of the user using reduced computing resources at the device control circuitry, for example because the device control circuitry may only have to analyse or process the gesture data elements rather than the motion sensor data.

It should be noted, though, that the motion detection circuitry can optionally be configured to provide the motion sensor data to the device control circuitry, and the device control circuitry can be configured to process or analyse some or all of the motion sensor data in addition to the gesture data. Such configuration may allow for a plausibility check of any gesture or gesture event determined by the aerosol-generating device.

Optionally, the device control circuitry can be further configured to determine a time period between detection of two consecutive gesture events based on determining a time period between receipt of two consecutive gesture data elements. Alternatively or additionally, a time period between consecutive gesture data elements transmitted by the motion detection circuitry to the device control circuitry may correspond to or correlate with a time period between detection of two consecutive gesture events at the motion detection circuitry. Optionally, the determined time period between consecutive gesture events can then be further used by the device control circuitry to determine the gesture and trigger the at least one device function associated therewith.

Accordingly, the device control circuitry may further be configured to determine the gesture based on one or more gesture data elements and based on (or based on determining) a time period between at least two consecutive gesture data elements and/or a time period between at least two consecutive gesture events.

In an example, single taps of a user onto the aerosol-generating device or a housing thereof may be detected by the motion detection circuitry and corresponding gesture data elements indicative of a single tap may be provided to the device control circuitry upon their detection at the motion detection circuitry. The device control circuitry may receive the gesture data elements and determine a time period between these two gesture data elements to detect whether the gesture performed by the user corresponds to a double tap. For example, the double tap may be detected by the device control circuitry if the determined time period between the single taps is within a predefined range and/or has a predefined value, which may be stored as reference data or reference motion data. The aerosol-generating device may then determine the at least one device function associated with the detected double tap and trigger the at least one device function.

Optionally, one or more gesture data elements indicative of a gesture event may include one or more of a time information related to the gesture event, a start time of the gesture event, a stop time of the gesture event, and a duration of the gesture event. Alternatively or additionally, the device control circuitry may be configured to determine the gesture based on one or more of a time information related to the gesture event, a start time of the gesture event, a stop time of the gesture event, and a duration of the gesture event. Accordingly, time information related to the gesture event, the start time of the gesture event, the stop time of the gesture event, and the duration of the gesture event can be determined at the motion detection circuitry and/or at the device control circuitry. Generally, taking time information of one or more gesture events into consideration for determining the gesture can increase a number of detectable gestures, such as series of rotations, displacements, and taps, and hence can allow to reliably detect complex gestures.

The device control circuitry may further be configured to determine the gesture based on and/or based on processing one or more gesture data elements provided by the motion sensor controller of the motion detection circuitry. For example, the device control circuitry can be configured to determine the gesture based on one or more of the following: The device control circuitry may be configured to determine a type of one or more gesture data elements (or gesture events) and/or may be configured to determine the gesture based thereon. Alternatively or additionally, the device control circuitry may be configured to determine a sequence of a plurality of gesture data elements (or gesture events) and/or to determine the gesture based thereon. Alternatively or additionally, the device control circuitry may be configured to determine a duration of one or more predefined gesture events associated with one or more gesture data elements and/or to determine the gesture based thereon. Alternatively or additionally, the device control circuitry may be configured to determine an occurrence of one or more gesture data elements (or gesture events) within a predetermined period of time and/or determine the gesture based thereon. Alternatively or additionally, the device control circuitry may be configured to determine a number of occurrences of gesture data elements (or gesture events) within a predetermined period of time and/or determine the gesture based thereon. Alternatively or additionally, the device control circuitry may be configured to determine a frequency of gesture data elements (or gesture events) and/or determine the gesture based thereon. Alternatively or additionally, the device control circuitry may be configured to determine a time period between two consecutive gesture data elements (or gesture events) and/or to determine the gesture based thereon.

The device control circuitry may further be configured to determine the gesture based on comparing at least a part of the gesture data to reference gesture data. The reference gesture data may for example be stored in a data storage of the aerosol-generating device and/or retrieved from an external source. Alternatively or additionally, the device control circuitry may be configured to determine the gesture based on one or more gesture data elements of the gesture data and based on one or more reference gesture data elements indicative of one or more gesture events. Accordingly, the reference gesture data may include one or more reference gesture data elements. Generally, the reference gesture data may be indicative of a predefined gesture, which may comprise one or more predefined gesture events. For example, the reference gesture data may define a gesture based on defining a specific gesture event or based on defining a plurality, sequence or series of gesture events the gesture is composed of.

For instance, the reference gesture data may define a gesture based on defining one or more of a type of one or more gesture events, a sequence of a plurality of events, a duration of one or more predefined gesture events, an occurrence of one or more gesture events within a predetermined period of time, a number of occurrences of gesture events within a predetermined period of time, a frequency of gesture events, and a time period between two or more consecutive gesture events.

The reference gesture data can be configured, defined and/or programmed by a manufacturer of the aerosol-generating device. Alternatively or additionally, reference gesture data can be defined or configured by a user, for example based on recording a certain gesture and storing reference gesture data for this gesture.

Accordingly, the device control circuitry can be configured to determine the at least one device function based on the determined gesture and/or based on one or more gesture data elements of the gesture data received from the motion detection circuitry in response to detection of the one or more gesture events at the motion detection circuitry.

A further aspect of the present disclosure relates to an aerosol-generating system, which comprises at least one aerosol-generating device, as described hereinabove and hereinbelow. The aerosol-generating system further includes one or both of an aerosol-generating article couplable to the aerosol-generating device and a receiving device configured to at least partly receive the aerosol-generating device.

The aerosol-generating article can for example be stick-like shaped, contain an aerosol-generating substrate or be configured to receive an aerosol-generating substrate. Alternatively or additionally, the aerosol-generating article can include a cartridge fillable with aerosol-generating liquid or substrate.

The aerosol-generating device and/or the aerosol-generating article may further include at least one heating element for heating at least a part of the aerosol-generating substrate of the aerosol-generating article to generate aerosol. Actuation of the heating element may, for example, be triggered by performing a certain gesture with the aerosol-generating device, detecting the gesture with the device control circuitry based on processing gesture data of the motion detection circuitry, and triggering the device function in response to the detection of the gesture at the device control circuitry.

The receiving device may, for example, be configured to store the aerosol-generating device. Alternatively or additionally, the aerosol-generating device may be charged or energy may be supplied by the receiving device. For storing electrical energy, the aerosol-generating device may comprise one or more energy storages, such as batteries, accumulators or capacitors.

A further aspect of the disclosure relates to a method of operating an aerosol-generating device and/or an aerosol-generating system including an aerosol-generating device. The method may at least partly or entirely relate to a computer-implemented method. The aerosol-generating device comprises motion detection circuitry with at least one motion sensor and a motion sensor controller. The aerosol-generating device further includes device control circuitry communicatively coupled to the motion detection circuitry. The method comprises the steps of:
processing, with the motion sensor controller of the motion detection circuitry, motion sensor data of the at least one motion sensor into gesture data indicative of a gesture performed on the aerosol-generating device by movement of the aerosol-generating device;
determining, based on analysing the gesture data with the device control circuitry, the gesture performed on the aerosol-generating device; and
controlling, with the device control circuitry, the aerosol-generating device to perform at least one device function in response to the determined gesture.

It is emphasized that any disclosure presented hereinabove and hereinbelow, which relates directly or indirectly to an aerosol-generating device or system, equally applies to the method of operating the aerosol-generating device or system, and vice versa.

The method may further comprise determining, with the motion sensor controller of the motion detection circuitry, at least one predefined gesture event in the gesture performed on the aerosol-generating device, for example by the user, or occurring in the gesture performed on the aerosol-generating device, and providing at least one gesture data element indicative of the at least one predefined gesture event to the device control circuitry.

The method may further comprise signalling, with the motion detection circuitry, detection of at least one predefined gesture event at the motion detection circuitry to the device control circuitry based on providing one or more gesture data elements indicative of the at least one predefined gesture event to the device control circuitry.

In an example, determining the at least one predefined gesture event can include detecting at least one motion pattern associated with the at least one gesture event in the motion sensor data. Optionally, detecting the at least one motion pattern can include comparing at least a part of the motion sensor data to reference motion data.

In an example, the method can further comprise determining, with the motion sensor controller of the motion detection circuitry, a sequence of a plurality of gesture events in the gesture performed on the aerosol-generating device, and providing a sequence of gesture data elements to the device control circuitry.

Determining the at least one gesture event at the motion detection circuitry may comprise determining, with the motion detection circuitry, one or more of the following: a predefined tilt of the aerosol-generating device with respect to one or more spatial directions; a predefined velocity of the aerosol-generating device in one or more spatial directions; a predefined acceleration of the aerosol-generating device in one or more spatial directions; a predefined translational movement of the aerosol-generating device along one or more spatial directions; a predefined acceleration about one or more of a longitudinal axis, a lateral axis, and a vertical axis of the aerosol-generating device; a predefined angular speed about one or more of a longitudinal axis, a lateral axis, and a vertical axis of the aerosol-generating device; a predefined rotational movement about one or more of a longitudinal axis, a lateral axis, and a vertical axis of the aerosol-generating device; a tap onto the aerosol-generating device or a housing thereof; a double-tap onto the aerosol-generating device or a housing thereof; a multi-tap onto the aerosol-generating device or a housing thereof; a shake performed with the aerosol-generating device; a double-shake performed with the aerosol-generating device; a multi-shake performed with the aerosol-generating device; and a predetermined period of inactivity, in which the aerosol-generating device may be substantially static. Any one or more of the above predefined gesture events may be determined by the motion detection circuitry, for example based on detecting one or more corresponding motion patterns in the motion sensor data. Further one or more corresponding gesture data elements may be generated and provided to the device control circuitry to signal detection of the one or more gesture events at the motion detection circuitry or by the motion detection circuitry.

The method may further comprise determining one or more of a time information related to the gesture event, a start time of the gesture event, a stop time of the gesture event, and a duration of the gesture event. This may be determined at the motion detection circuitry and included or encoded in respective one or more gesture data elements. Alternatively or additionally, such information may be determined by the device control circuitry based on processing the respective one or more gesture elements provided by the motion detection circuitry.

The method may further comprise determining, with the device control circuitry, the gesture performed on the aerosol-generating device based on analysing one or more gesture data elements provided by the motion sensor controller of the motion detection circuitry. For example, the gesture may be determined by the device control circuitry based on determining one or more of a type of one or more gesture data elements (or gesture events), a sequence of a plurality of gesture data elements (or gesture events); a duration of one or more predefined gesture events associated with one or more gesture data elements, an occurrence of one or more gesture data elements (or gesture events) within a predetermined period of time, a number of occurrences of gesture data elements (or gesture events) within a predetermined period of time, a frequency of gesture data elements (or gesture events), and a time period between two consecutive gesture data elements (or gesture events).

For example, the gesture may be determined by the device control circuitry based on comparing at least a part of the gesture data to reference gesture data. Alternatively or additionally, the gesture may be determined by the device control circuitry based on comparing one or more gesture data elements of the gesture data to one or more reference gesture data elements indicative of one or more predefined gesture events.

The method may further comprise determining, with the device control circuitry, the at least one device function based on the determined gesture and/or based on one or more gesture data elements of the gesture data. The method may further comprise performing and/or executing the determined at least one device function. This may, for example, include actuating one or more components of the aerosol-generating device in correspondence with the determined at least one device function.

Executing a device function may also include suppressing or inhibiting one or more functions of the aerosol-generating device. For example, when a free-fall of the device is detected, actuation of a heating element may be suppressed.

As described hereinabove, exemplary device functions may include one or more of altering an operational mode of the aerosol-generating device, altering a power state of the aerosol-generating device, altering a configuration of the aerosol-generating device, altering a locked state of the aerosol-generating device; actuating a user interface of the aerosol-generating device; controlling a user interface of the aerosol-generating device to provide information to the user; controlling one or more settings of the aerosol-generating device; resetting the aerosol-generating device; controlling a heating element of the aerosol-generating device; controlling a heating element of an aerosol-generating article couplable to the aerosol-generating device to generate aerosol; and controlling a heating temperature of the aerosol-generating device.

According to a further aspect of the present disclosure, there is provided a computer program, which, when executed by an aerosol-generating device or an aerosol-generating system, instructs the aerosol-generating device or system to perform steps of the method, as described hereinabove and hereinbelow.

According to a further aspect of the present disclosure, there is provided a non-transitory computer-readable medium storing a computer program which, when executed by an aerosol-generating device or an aerosol-generating system, instructs the aerosol-generating device or system to perform steps of the method, as described hereinabove and hereinbelow.

A further aspect of the present disclosure may relate to the use of an aerosol-generating device or system, as described hereinabove and hereinbelow.

Below, there is provided a non-exhaustive list of non-limiting examples (abbreviated “Ex.”). Any one or more of the features of these examples may be combined with any one or more features of another example, embodiment, or aspect described herein.
Ex. 1: An aerosol-generating device, comprising:
   motion detection circuitry including at least one motion sensor and a motion sensor controller configured to process motion sensor data of the at least one motion sensor into gesture data indicative of a gesture performed on the aerosol-generating device by movement of the aerosol-generating device, for example a gesture performed by a user of the aerosol-generating device by mechanical interaction with the aerosol-generating device; and
   device control circuitry including one or more device processors configured to determine, based on analysing the gesture data provided by the motion sensor controller of the motion detection circuitry, the gesture performed on the aerosol-generating device, for example the gesture performed by the user, and to control the aerosol-generating device to perform at least one device function in response to the determined gesture.
Ex. 2: The aerosol-generating device according to example 1, wherein the gesture data provided by the motion sensor controller of the motion detection circuitry include one or more gesture data elements indicative of a predefined gesture event in the gesture performed on the aerosol-generating device, for example performed by the user; and/or
wherein the gesture data include one or more gesture data elements for signalling detection of one or more predefined gesture events at the motion detection circuitry to the device control circuitry.
Ex. 3: The aerosol-generating device according to any one of examples 1 and 2, wherein the motion sensor controller of the motion detection circuitry is configured to determine at least one predefined gesture event in the gesture performed on the aerosol-generating device, for example performed, based on processing the motion sensor data, and to signal detection of the at least one predefined gesture event to the device control circuitry based on providing one or more gesture data elements indicative of the at least one predefined gesture event.
Ex. 4: The aerosol-generating device according to any one of examples 1 to 3,
   wherein the motion sensor controller of the motion detection circuitry is configured to determine at least one predefined gesture event in the gesture performed on the aerosol-generating device, for example performed by the user, based on detecting at least one motion pattern associated with the at least one gesture event in the motion sensor data; and
   wherein the motion sensor controller of the motion detection circuitry is configured to provide at least one gesture data element indicative of the determined at least one gesture event to the device control circuitry.
Ex. 5: The aerosol-generating device according to example 4, wherein the motion sensor controller of the motion detection circuitry is configured to detect the at least one motion pattern based on comparing at least a part of the motion sensor data to reference motion data.
Ex. 6: The aerosol-generating device according to any one of examples 1 to 5, wherein the motion sensor controller of the motion detection circuitry is configured to determine a sequence of a plurality of gesture events in the gesture performed on the aerosol-generating device, for example performed by the user, and provide a sequence of gesture data elements to the device control circuitry.
Ex. 7: The aerosol-generating device according to any one of examples 2 to 6, wherein the predefined gesture event is of one or more of:
a predefined tilt of the aerosol-generating device with respect to one or more spatial directions;
a predefined velocity of the aerosol-generating device in one or more spatial directions;
a predefined acceleration of the aerosol-generating device in one or more spatial directions;
a predefined translational movement of the aerosol-generating device along one or more spatial directions;
a predefined acceleration about one or more of a longitudinal axis, a lateral axis, and a vertical axis of the aerosol-generating device;
a predefined angular speed about one or more of a longitudinal axis, a lateral axis, and a vertical axis of the aerosol-generating device;
a predefined rotational movement about one or more of a longitudinal axis, a lateral axis, and a vertical axis of the aerosol-generating device;
a tap;
a double-tap;
a multi-tap
a shake;
a double-shake;
a multi-shake; and
a predetermined period of inactivity.
Ex. 8: The aerosol-generating device according to any one of examples 2 to 7, wherein the predefined gesture event is configurable.
Ex. 9: The aerosol-generating device according to any one of examples 2 to 8, wherein the one or more gesture data elements include one or more of a time information related to the gesture event, a start time of the gesture event, a stop time of the gesture event, and a duration of the gesture event.
Ex. 10: The aerosol-generating device according to any one of examples 1 to 9, wherein the device control circuitry is further configured to determine the gesture based on one or more gesture data elements provided by the motion sensor controller of the motion detection circuitry.
Ex. 11: The aerosol-generating device according to any one of examples 1 to 10, wherein the device control circuitry is further configured to determine the gesture based on one or more of:
a type of one or more gesture data elements;
a sequence of a plurality of gesture data elements;
a duration of one or more predefined gesture events associated with one or more gesture data elements;
an occurrence of one or more gesture data elements within a predetermined period of time;
a number of occurrences of gesture data elements within a predetermined period of time;
a frequency of gesture data elements;
a time period between two consecutive gesture data elements.
Ex. 12: The aerosol-generating device according to any one of examples 1 to 11,
   wherein the device control circuitry is configured to determine the gesture performed on the aerosol-generating device, for example performed by the user, based on comparing at least a part of the gesture data to reference gesture data; and/or
wherein the device control circuitry is configured to determine the gesture performed on the aerosol-generating device, for example performed by the user, based on comparing one or more gesture data elements of the gesture data to one or more reference gesture data elements indicative of one or more predefined gesture events.
Ex. 13: The aerosol-generating device according to example 12, wherein the reference gesture data is stored in a data storage of the device control circuitry and/or is retrieved from an external data source.
Ex. 14: The aerosol-generating device according to any one of examples 12 and 13, wherein the reference gesture data is configurable.
Ex. 15: The aerosol-generating device according to any one of examples 1 to 14, wherein the device control circuitry is further configured to determine the at least one device function based on the determined gesture and/or based on one or more gesture data elements of the gesture data.
Ex. 16: The aerosol-generating device according to any one of examples 1 to 15, wherein the at least one device function includes one or more of:
altering an operational mode of the aerosol-generating device;
altering a power state of the aerosol-generating device;
altering a configuration of the aerosol-generating device;
altering a locked state of the aerosol-generating device;
actuating a user interface of the aerosol-generating device;
controlling a user interface of the aerosol-generating device to provide information to the user;
controlling one or more settings of the aerosol-generating device;
resetting the aerosol-generating device;
controlling a heating element of the aerosol-generating device;
controlling a heating element of an aerosol-generating article couplable to the aerosol-generating device to generate aerosol; and
controlling a heating temperature of the aerosol-generating device.
Ex. 17: The aerosol-generating device according to any one of examples 1 to 16, wherein the motion detection circuitry and/or the at least one motion sensor of the motion detection circuitry includes one or more of a tilt sensor, an accelerometer, a gyroscope, a pressure sensor, a barometer, and a position sensor.
Ex. 18: An aerosol-generating system, comprising:
   an aerosol-generating device according to any one of examples 1 to 17; and
   an aerosol-generating article couplable to the aerosol-generating device and/or a receiving device configured to at least partly receive the aerosol-generating device.
Ex. 19: A method of operating an aerosol-generating device including motion detection circuitry with at least one motion sensor and a motion sensor controller, and including device control circuitry communicatively coupled to the motion detection circuitry, the method comprising:
processing, with the motion sensor controller of the motion detection circuitry, motion sensor data of the at least one motion sensor into gesture data indicative of a gesture performed on the aerosol-generating device by movement of the aerosol-generating device, for example performed by a user of the aerosol-generating device by mechanical interaction with the aerosol-generating device;
   determining, based on analysing the gesture data with the device control circuitry, the gesture performed on the aerosol-generating device, for example performed by the user; and
controlling, with the device control circuitry, the aerosol-generating device to perform at least one device function in response to the determined gesture.
Ex. 20: The method according to example 19, further comprising:
determining, with the motion sensor controller of the motion detection circuitry, at least one predefined gesture event occurring in the gesture performed on the aerosol-generating device, for example performed by the user; and/or
providing at least one gesture data element indicative of at least one predefined gesture event to the device control circuitry.
Ex. 21: The method according to any of examples 19 and 20, further comprising:
signalling, with the motion detection circuitry, detection of at least one predefined gesture event at the motion detection circuitry to the device control circuitry based on providing one or more gesture data elements indicative of the at least one predefined gesture event to the device control circuitry.
Ex. 22: The method according to any one of examples 20 and 21, wherein determining the at least one predefined gesture event includes detecting at least one motion pattern associated with the at least one gesture event in the motion sensor data.
Ex. 23: The method according to example 22, wherein detecting the at least one motion pattern includes comparing at least a part of the motion sensor data to reference motion data.
Ex. 24: The method according to any one of examples 19 to 23, further comprising:
determining, with the motion sensor controller of the motion detection circuitry, a sequence of a plurality of gesture events in the gesture performed on the aerosol-generating device, for example performed by the user; and
providing a sequence of gesture data elements to the device control circuitry.
Ex. 25: The method according to any one of examples 19 to 24, further comprising determining, with the motion detection circuitry, one or more of:
a predefined tilt of the aerosol-generating device with respect to one or more spatial directions;
a predefined velocity of the aerosol-generating device in one or more spatial directions;
a predefined acceleration of the aerosol-generating device in one or more spatial directions;
a predefined translational movement of the aerosol-generating device along one or more spatial directions;
a predefined acceleration about one or more of a longitudinal axis, a lateral axis, and a vertical axis of the aerosol-generating device;
a predefined angular speed about one or more of a longitudinal axis, a lateral axis, and a vertical axis of the aerosol-generating device;
a predefined rotational movement about one or more of a longitudinal axis, a lateral axis, and a vertical axis of the aerosol-generating device;
a tap;
a double-tap;
a multi-tap
a shake;
a double-shake;
a multi-shake; and
a predetermined period of inactivity.
Ex. 26: The method according to any one of examples 20 to 25, further comprising:
determining one or more of a time information related to the gesture event, a start time of the gesture event, a stop time of the gesture event, and a duration of the gesture event.
Ex. 27: The method according to any one of examples 19 to 26, wherein the gesture is determined by the device control circuitry based on analysing one or more gesture data elements provided by the motion sensor controller of the motion detection circuitry.
Ex. 28: The method according to any one of examples 19 to 27, wherein determining the gesture further comprises determining, with the device control circuitry, on one or more of:
a type of one or more gesture data elements;
a sequence of a plurality of gesture data elements;
a duration of one or more predefined gesture events associated with one or more gesture data elements;
an occurrence of one or more gesture data elements within a predetermined period of time;
a number of occurrences of gesture data elements within a predetermined period of time;
a frequency of gesture data elements;
a time period between two consecutive gesture data elements.
Ex. 29: The method according to any one of examples 19 to 28, wherein the gesture is determined by the device control circuitry based on comparing at least a part of the gesture data to reference gesture data; and/or
wherein the gesture is determined by the device control circuitry based on comparing one or more gesture data elements of the gesture data to one or more reference gesture data elements indicative of one or more predefined gesture events.
Ex. 30: The method according to any one of examples 19 to 29, further comprising:
determining, with the device control circuitry, the at least one device function based on the determined gesture and/or based on one or more gesture data elements of the gesture data; and/or
triggering, with the device control circuitry, the at least one device function.
Ex. 31: The method according to any one of examples 19 to 30, wherein the at least one device function includes one or more of:
altering an operational mode of the aerosol-generating device;
altering a power state of the aerosol-generating device;
altering a configuration of the aerosol-generating device;
altering a locked state of the aerosol-generating device;
actuating a user interface of the aerosol-generating device;
controlling a user interface of the aerosol-generating device to provide information to the user;
controlling one or more settings of the aerosol-generating device;
resetting the aerosol-generating device;
controlling a heating element of the aerosol-generating device;
controlling a heating element of an aerosol-generating article couplable to the aerosol-generating device to generate aerosol; and
controlling a heating temperature of the aerosol-generating device.
Ex. 32: A computer program, which when executed by an aerosol-generating device or an aerosol-generating system, instructs the aerosol-generating device or system to perform steps of the method according to any one of examples 19 to 31.
Ex. 33: Non-transitory computer-readable medium storing the computer program according to example 32.

Examples will now be further described with reference to the Figures in which:

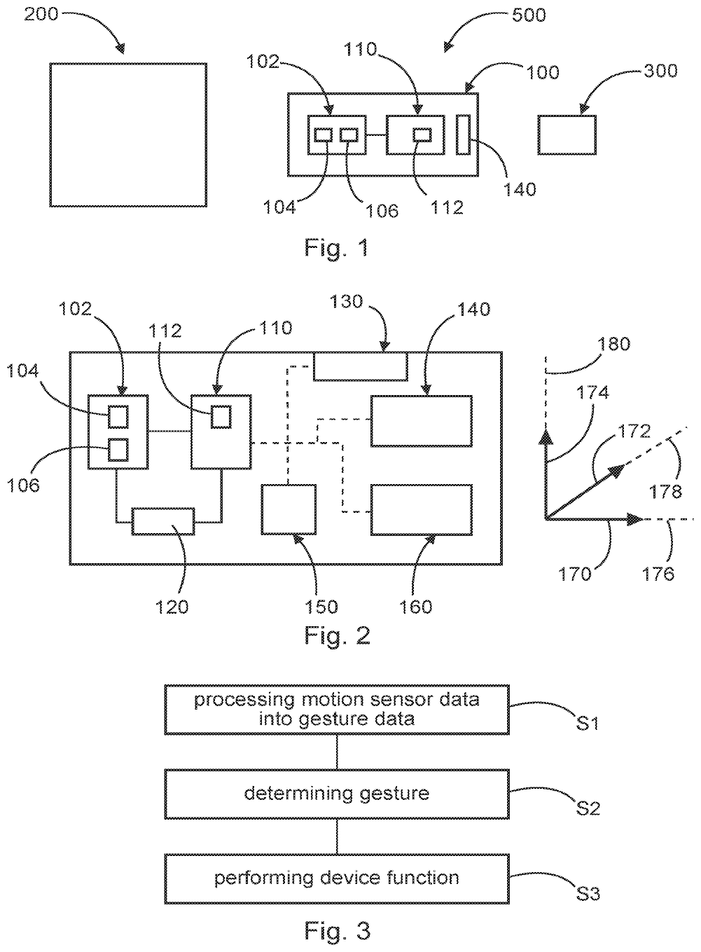

FIG. 1 shows an aerosol-generating system;

FIG. 2 shows an aerosol-generating device; and

FIG. 3 shows a flowchart illustrating a method of operating an aerosol-generating device or system.

The Figures are schematic only and not true to scale. In principle, identical or like parts, elements and/or steps are provided with identical or like reference numerals in the Figures.

FIG. 1 shows an aerosol-generating system 500 for generating aerosol. The aerosol-generating system 500 comprises an aerosol-generating device 100 for generating aerosol. The aerosol-generating device 100 illustrated in FIG. 1 is shown in a more detailed view in FIG. 2 and will be described in the following with reference to one or both FIG. 1 and FIG. 2.

The aerosol-generating system 500 further comprises an aerosol-generating article 300, which can for example be stick-like shaped and contain an aerosol-generating substrate. Alternatively or additionally, the aerosol-generating article 300 can include a cartridge fillable with aerosol-generating liquid or substrate.

The aerosol-generating device 100 further includes at least one heating element 140 for heating at least a part of the aerosol-generating substrate of the aerosol-generating article 300 to generate aerosol. As will be described in more detail hereinafter, actuation of the heating element 140 may, for example, be triggered by performing a certain gesture with the aerosol-generating device 100. Alternatively or additionally to arranging the heating element 140 in the aerosol-generating device 100, the heating element 140 or a part thereof may be arranged in the aerosol-generating article 300. The aerosol-generating article 300 may be coupled to the aerosol-generating device 100 and by actuating the heating element 140 at least a part of the aerosol-generating substrate may be heated to generate aerosol.

The aerosol-generating system 500. Further includes a receiving device 200 that can be configured to store the aerosol-generating device 100. Alternatively or additionally, the aerosol-generating device 100 may be charged or energy may be supplied by the receiving device 200. For storing electrical energy, the aerosol-generating device 100 can comprise one or more energy storages 160, such as batteries, accumulators or capacitors.

As shown in more detail in FIG. 2, the aerosol-generating device 100 comprises motion detection circuitry 102 with at least one motion sensor 104 for determining and/or acquiring motion sensor data indicative of a motion of the aerosol-generating device 100, including a motion caused by a user performing a gesture with the aerosol-generating device 100 based on mechanically interacting with the device 100.

The motion sensor 104 may include at least one tilt sensor for detecting a tilt of the aerosol-generating device 100, at least one (single or multi axis) accelerometer for detecting acceleration of the aerosol-generating device 100 parallel to and/or about one or more axes 176, 178, 180, at least one gyroscope for detecting rotational changes, rotational speed, for instance in degrees per second, and/or motions of the aerosol-generating device 100 about one or more axes 176, 178, 180, and/or at least one position sensor, such as a global positioning sensor (GPS), for detecting a geographical position of the aerosol-generating device 100 and/or a change in geographical position. Alternatively or additionally, one or more pressure sensors and/or barometers may be utilized for detecting changes in altitude, altitude above sea level, and/or vertical position of the aerosol-generating device. For example, such changes in altitude may be caused by a user lifting or picking-up the aerosol-generating device or by moving the aerosol-generating device vertically parallel to z-axis 180 in FIG. 2. The one or more pressure sensors may, for example, be configured to detect changes in vertical direction 174 of about 1 cm, for example about 10 cm, and above. It is emphasized that one or more of such sensors or sensor types can be combined in the at least one motion sensor 104 or motion detection circuitry 102, such as for example an accelerometer-gyroscope sensor combination.

Motion detection circuitry 102 and/or motion sensor 104 is configured to detect a motion, displacement, velocity, positional change, orientation, orientational change, rotation, rotational change and/or acceleration of the aerosol-generating device 100 in one or more spatial directions 170, 172, 174, parallel to one or more axes 176, 178, 180 of the aerosol-generating device 100 and/or around one or more axes 176, 178, 180 of the aerosol-generating device 100. Axes 176, 178, 180 may be referred to as longitudinal axis 176 (or x-axis 176 or roll axis 176), lateral axis 178 (or y-axis or transversal axis or pitch axis 178) and vertical axis 180 (or yaw axis 180 or perpendicular axis) of the aerosol-generating device 100. Alternative or additionally, the motion sensor 104 may be configured to determine motion sensor data indicative of a motion, displacement, velocity, positional change, orientation, orientational change, rotation, rotational change and/or acceleration of the aerosol-generating device 100 in one or more spatial directions 170, 172, 174, parallel to one or more axes 176, 178, 180 of the aerosol-generating device 100 and/or around one or more axes 176, 178, 180 of the aerosol-generating device 100.

The motion sensor data may refer to or denote raw sensor data provided, determined and/or generated by the motion sensor 104 of the motion detection circuitry 102 in response to sensing and/or detecting a motion, displacement, velocity, positional change, orientation, orientational change, rotation, rotational change and/or acceleration of the aerosol-generating device 100. For example, the motion sensor data may include one or more of positional data, acceleration data, angular rate data and orientation data, for example one to six axes orientation data.

Motion sensor data acquired with the at least one motion sensor 104 is output to a motion sensor controller 106 of the motion detection circuitry 102 and processed by motion sensor controller 106 into gesture data indicative of the gesture performed on the aerosol-generating device, for example performed by the user with the aerosol-generating device 100. Therein, motion sensor controller 106 may include one or more processors, microprocessors or microcontrollers. For example, the motion sensor controller 106 may be configured to analyse the motion sensor data to determine, compute and/or generate the gesture data.

The motion detection circuitry 102 may be designed or configured as smart sensor and/or MEMS, for example in the form of a single component or member. Alternatively, motion detection circuitry 102 may be implemented as electronic circuitry with a plurality of components, for example arranged on a substrate or circuit board.

The aerosol-generating device 100 further includes a device control circuitry 110 with one or more processors, device processors, microprocessors or microcontrollers 112 configured to receive and/or process the gesture data provided by the motion detection circuitry 102 in order to determine a gesture performed on the aerosol-generating device, for example performed by the user with the aerosol-generating device 100. In the following, exemplary functions or functionalities of the aerosol-generating device 100, the motion detection circuitry 102 and the device control circuitry 110 are described, which may be utilized isolated or in combination to provide gesture control for the aerosol-generating device 100.

For example, the gesture data provided by the motion sensor controller 106 of the motion detection circuitry 102 can include one or more gesture data elements indicative of a predefined gesture event in the gesture performed on the aerosol-generating device. Accordingly, the motion sensor controller 106 of the motion detection circuitry 102 can be configured to determine at least one predefined gesture event based on processing the motion sensor data and to signal detection of the at least one predefined gesture event to the device control circuitry 110 based on providing one or more gesture data elements indicative of the at least one predefined gesture event. To detect the at least one gesture event, the motion detection circuitry 102 and/or the motion sensor controller 104 thereof can be configured to detect at least one motion pattern or predefined motion pattern associated with the at least one predefined gesture event in the motion sensor data, and to provide at least one gesture data element indicative of the determined at least one gesture event to the device control circuitry 110.

The at least one motion pattern associated with the at least one gesture event can, for example, be detected based on state machine detection and/or based on reference motion data. Reference motion data can for example be stored in a data storage 120 of the aerosol-generating device 100 and/or retrieved from an external source, for example via a communication interface 150 of the aerosol-generating device 100.

The motion detection circuitry 102 can be configured to monitor any motion of the aerosol-generating device 100 and to provide one or more gesture data elements to the device control circuitry 110 upon detection of one or more gesture events. For example, the motion sensor controller 106 of the motion detection circuitry 102 can be configured to determine a sequence of a plurality of gesture events in the gesture performed on the aerosol-generating device, for example by the user, and provide a sequence of gesture data elements to the device control circuitry 110. Based on one or more of the gesture data elements, the device control circuitry 110 may detect the gesture performed on the aerosol-generating device and control one or more device functions of the aerosol-generating device 100, which one or more device functions are associated with the detected gesture.

Examples of gesture events detected at the motion detection circuitry 102 can be a predefined tilt of the aerosol-generating device 100 with respect to one or more spatial directions 170, 172, 174, a predefined velocity of the aerosol-generating device 100 in one or more spatial directions 170, 172, 174, a predefined acceleration of the aerosol-generating device 100 in one or more spatial directions 170, 172, 174, a predefined translational movement or displacement of the aerosol-generating device 100 along one or more spatial directions 170, 172, 174, a predefined acceleration about one or more axes 176, 178, 180 of the aerosol-generating device 100, a predefined angular speed about one or more axes 176, 178, 180 of the aerosol-generating device 100, a predefined rotational movement about one or more axes 176, 178, 180 of the aerosol-generating device 100, a tap performed by the user onto the aerosol-generating device 100, a double-tap performed by the user onto the aerosol-generating device 100, a multi-tap performed by the user onto the aerosol-generating device 100, a shake performed with the aerosol-generating device 100, a double-shake, a multi-shake, and a predetermined period of inactivity.

The device control circuitry 110 can be configured to determine the gesture based on one or more gesture data elements provided by the motion sensor controller 106 of the motion detection circuitry 102. For instance, the device control circuitry 110 can be configured to determine the gesture based on one or more of a type of one or more gesture data elements or events, a sequence of a plurality of gesture data elements or events, a duration of one or more predefined gesture events associated with one or more gesture data elements, an occurrence of one or more gesture data elements or events within a predetermined period of time, a number of occurrences of gesture data elements or events within a predetermined period of time, a frequency of gesture data elements or events, a time period between two consecutive gesture data elements or events. Any one or more of such features can be determined by the device control circuitry 110 to detect the gesture performed on the aerosol-generating device, for example based on reference gesture data, which may be stored in a data storage 120 of the aerosol-generating device 100.

It is noted that a common data storage 120 for the motion detection circuitry 102 and the device control circuitry 110 is exemplary shown in FIG. 2. Alternatively, separate data storages for the motion detection circuitry 102 and the device control circuitry 110 may be utilized.

The device control circuitry 110 can further be configured to determine the at least one device function based on the determined gesture and/or based on one or more gesture data elements of the gesture data. Performing or executing the at least one device can include actuating one or more components of the aerosol-generating device 100, such as the heating element 140, the energy storage 160, the communication interface 150, one or more user interfaces 130 of the aerosol-generating device 100 or any other component of the aerosol-generating device 100. The aerosol-generating device 100 shown in FIG. 2 includes an exemplary user interface 130 for outputting information to the user and/or for receiving one or more user inputs.

The device control circuitry 110, upon detection of the gesture, can be configured to alter an operational mode of the aerosol-generating device 100, to alter a power state of the aerosol-generating device 100, to alter a configuration of the aerosol-generating device 100, to alter a locked state of the aerosol-generating device 100, to actuate the user interface 130 of the aerosol-generating device 100, to control the user interface 120 of the aerosol-generating device 100 to provide information to the user, to control one or more settings of the aerosol-generating device 100, to reset the aerosol-generating device 100, to control the heating element 140 of the aerosol-generating device 100, to control a heating element of an aerosol-generating article 300 couplable to the aerosol-generating device 100 to generate aerosol, and/or to control a heating temperature of the aerosol-generating device 100 or the at least one heating element 140. Displaying information on the user interface 130 may include retrieving information from the energy storage 160 about a charge level and/or retrieving information from the aerosol-generating article 300, for example about a fill level or condition of the aerosol-generating substrate.

In the following, various exemplary features, functions or functionalities of the aerosol-generating device 100 or system 500 are summarized. Motion detection circuitry 100 can for example comprise coding means and/or be configured to operate an analysis whether a movement determined with motion sensor 102 relates to or can be mapped to a predefined gesture event. The motion detection circuitry 102 can then transfer the information to the device control circuitry 110 as gesture data and/or as one or more gesture data elements. For this purpose, motion detection circuitry 102 may implement hard-coded detection blocks and/or soft-coded detection blocks, which may be configurable.

For detecting a gesture performed on the aerosol-generating device, for example performed by the user, a first level processing or pre-processing of the motion sensor data acquired with the motion sensor 104 can be done by the motion detection circuitry 102 or the motion sensor controller 104 thereof. For instance, one or more gesture events may be detected by the motion detection circuitry 102 and one or more gesture data elements indicative thereof may be transmitted to the device control circuitry 110. In a second level processing, the device control circuitry 110 or the at least one device processor 112 thereof can determine what gesture has been performed, and/or and the functional response to the gesture. Accordingly, motion detection circuitry 102 can detect what gesture event(s) occurred (for example a shake, a slow pick-up, a tap, a rotation, a displacement etc.) and then the device control circuitry 110 can perform an analysis of the corresponding gesture data or gesture data elements to determine the gesture performed on the aerosol-generating device. Also, device control circuitry 110 can decide what kind of device function(s) are to be executed in response to the gesture and/or can perform one or more device functions in response to detecting a certain gesture.

The motion detection circuitry 102 may include one or more detection blocks for detecting one or more gesture events. For example, the motion detection circuitry 102 can comprise one or more of a hard-coded detection block, a soft-coded detection block, and a state-machine detection block. Alternatively or additionally, a detection block using Machine Learning may be implemented in the motion detection circuitry 102 to detect one or more gesture events based on or using an artificial intelligence module, which may be trained to detect certain gesture events in the motion sensor data. A hard-coded detection block can, for example, be pre-programmed and/or configurable, for example in terms of a threshold, a duration, a number of taps and the like. A soft-coded detection block can be programmed for a specific motion pattern, for example including one or more of an acceleration, rotation and angular speed.

Upon detecting one or more motion patterns in the motion sensor data, the motion detection circuitry 102 can output a signal to the device control circuitry 110, for example a signal containing the gesture data and/or one or more gesture data elements, thereby informing the device control circuitry 110 that one or more particular gesture events have been detected.

Such signal can, for example, comprise an interrupt signal, which may correspond to a bit carrying a piece of information that an input is going to be communicated to the device control circuitry 110 or device processor 112. It can be processed very quickly by device control circuitry 110 or device processor 112 and/or wake up the device control circuitry 110 or device processor 112. Accordingly, the device control circuitry 110 or processor 112, which is also referred to as main application processor or device processor 112 and which may have a rather high energy consumption, may enter into a low-power mode or sleep mode and rely on the motion detection circuitry 102 to be waken up whenever a predefined gesture event is detected by the motion detection circuitry 102. Accordingly, an interrupt signal transmitted to the device control circuitry 110 can refer to a wake-up signal if the device control circuitry 110 or device processor 112 is in sleep mode, or to an input signal if the device control circuitry 110 or device processor 112 is awake indicating that a predefined gesture event has been detected. In both cases, such piece of information can be followed by the signal or data associated with the detected gesture event(s), such as at least one gesture data element.

Accordingly, motion detection circuitry 102 or motion sensor controller 106 and device control circuitry 110 or device processor 112 can operate independently from one another, wherein the motion sensor controller 106 of the motion detection circuitry 102 can be configured to detect one or more gesture events in the motion sensor data and signal the one or more gesture events to the device processor 112 based on providing or computing one or more gesture data elements. The device processor 112 of the device control circuitry 110 can further detect the gesture based on the one or more gesture events signalled by the motion detection circuitry 102.

Generally, motion detection circuitry 102 and device control circuitry 110 can refer to physically and functionally separate or independent components, for example which may be arranged in the device 100 in different locations and/or which may have dedicated tasks.

In the following an example for detecting a double tap performed by the user onto the aerosol-generating device 100 is described. The gesture of the double tap may include two distinct gestural interactions of a single tap, separated by a certain period of time or time interval. Both gestural interactions may correspond to a single gesture event “double tap” and may be detected by the motion sensor controller 106 of the motion detection circuitry 102 as double tap. Upon detecting the double tap, the motion detection circuitry 102 may provide a corresponding gesture data element to the device control circuitry 110 and the device control circuitry 110 can perform at least one device function associated with the double tap or gesture. For actually detecting the double tap as gesture event, for example an amplitude of the single taps and a time interval between the taps can be customized or predefined in the motion detection circuitry 102, for example based on defining corresponding reference motion data.

Alternatively, a double tap can be detected by the motion detection circuitry 102 as two consecutive single taps or gesture events, separated by a certain period of time. The motion detection circuitry 102 can be configured to signal the single taps to the device control circuitry 110 by providing a corresponding gesture element to the device control circuitry 110 for each of the detected gesture events “single tap”, and the device control circuitry 110 can be configured to determine the time period between the two gesture events. For example, if the detected time period is within a certain range or has a certain value, the device control circuitry 110 can detect the gesture “double tap” and trigger the associated device function.

To detect various gesture events or gestures, a number of dedicated state-machines can be used at the motion detection circuitry 102, and each of those can be programmed to detect a specific or predefined motion pattern or gesture event.

As an example, the motion detection circuitry 102 can be configured to detect a specific motion pattern where the acceleration goes up by x % and then goes down by y %, followed by no acceleration and then a further acceleration within a time frame of 30 milliseconds. In general, it will be appreciated that a plurality motion patterns, which may correspond to specific signature gestures, may be programmed based on storing corresponding reference motion data and can be detected by the motion detection circuitry 102.

By distributing the computing burden for the overall gesture control among the motion sensor controller 106 of the motion detection circuitry 102 and the device processor 112 of the device control circuitry, a processing burden can be reduced at the device processor's 112 side. This could leave more capacity to handle its own functions, such as for example computing heating control regulations. Optionally, a dedicated microprocessor for controlling the heating element 140 may be utilized.

As described above, the information received from the motion detection circuitry 102 by the device control circuitry 110, in particular the gesture data and/or gesture data elements, can be used by the device control circuitry 110 to recognize the gesture performed on the aerosol-generating device. As an example, a double tap followed by a rotation, or a shake within a certain time interval could be defined as gesture and detected by the device control circuitry 110, for example based on defining corresponding reference gesture data. This can provide a new way of interacting with aerosol-generating device 100. Accordingly, the device control circuitry 110 can assign a specific device function to a gesture comprising one or more gesture events detected by the motion detection circuitry 102.

As mentioned above, in an example of single/double tap gesture recognition, single taps can be detected at the motion detection circuitry 102. When a double tap is carried out, corresponding gesture data elements can be sent from the motion detection circuitry 102 to the device control circuitry 110 and the latter can assess whether the input is a single or a double tap by analysing the time interval between the taps or gesture events and operate the function associated to a single or a double tap based on said time interval, for instance in dependence of the time interval being above or below a predefined time threshold, which may be defined in reference gesture data. Accordingly, a double tap can be detected as two single taps, and then the calculation of time between the two taps can be determined by the device control circuitry 110. Alternatively, however, a double tap may be detected as gesture event by the motion detection circuitry 102.

Optionally, a “free-fall detection” can be implemented in the motion detection circuitry 102 to filter events resulting from dropping the aerosol-generating device 100 rather than tapping or double tapping by the user.

Generally, merging the pre-processed information from the motion detection circuitry 102 in the device control circuitry 110 can deliver a better and more accurate gesture detection.

Accordingly, the device control circuitry 110 can be configured to receive a sequence of inputs x, y, for instance gesture data or gesture data element(s), and associate one or more device functions z based on said sequence of inputs x, y and possibly one or more further pre-set conditions.

FIG. 3 shows a flowchart illustrating a method of operating an aerosol-generating device 100 or an aerosol-generating system 500, for example as described with reference to one or both FIG. 1 and FIG. 2.
Step S1 of the method comprises processing, with the motion sensor controller 106 of the motion detection circuitry 102, motion sensor data of the at least one motion sensor 104 into gesture data indicative of a gesture performed by a user of the aerosol-generating device 100 by mechanical interaction with the aerosol-generating device 100.
Step S2 comprises determining, based on analyzing the gesture data with the device control circuitry 110, the gesture performed on the aerosol-generating device.
Step S3 comprises controlling, with the device control circuitry 110, the aerosol-generating device 100 to perform at least one device function in response to the determined gesture.

The method according to FIG. 3 may comprise one or more optional steps. In particular any function of the aerosol-generating device 100 as described hereinabove can be performed as optional step.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-21. (canceled)

22. An aerosol-generating device, comprising:
motion detection circuitry including at least one motion sensor and a motion sensor controller configured to process motion sensor data of the at least one motion sensor into gesture data indicative of a gesture performed on the aerosol-generating device by movement of the aerosol-generating device; and
device control circuitry including one or more device processors configured to determine, based on analyzing the gesture data provided by the motion sensor controller of the motion detection circuitry, the gesture performed on the aerosol-generating device and to control the aerosol-generating device to perform at least one device function in response to the determined gesture.

23. The aerosol-generating device according to claim 22,
wherein the gesture data provided by the motion sensor controller of the motion detection circuitry include one or more gesture data elements indicative of a predefined gesture event in the gesture performed on the aerosol-generating device, and/or
wherein the gesture data include one or more gesture data elements for signaling detection of one or more predefined gesture events at the motion detection circuitry to the device control circuitry.

24. The aerosol-generating device according to claim 22,
wherein the motion sensor controller of the motion detection circuitry is configured to determine at least one predefined gesture event in the gesture performed on the aerosol-generating device based on processing the motion sensor data, and
wherein the motion sensor controller of the motion detection circuitry is further configured to signal detection of the at least one predefined gesture event to the device control circuitry based on providing one or more gesture data elements indicative of the at least one predefined gesture event.

25. The aerosol-generating device according to claim 22,
wherein the motion sensor data includes raw sensor data generated by the at least one motion sensor of the motion detection circuitry in response to sensing one or more of a motion, a positional change, a rotation, an orientational change, a rotational change, and an acceleration of the aerosol-generating device, and
wherein the motion sensor controller is configured to compute the gesture data based on the motion sensor data.

26. The aerosol-generating device according to claim 22, wherein the motion detection circuitry is further configured to generate the gesture data based on determining information in the motion sensor data descriptive of the gesture performed on the aerosol-generating device.

27. The aerosol-generating device according to claim 22,
wherein the at least one motion sensor is configured to provide time-related motion sensor data on a first time scale, and
wherein the motion sensor controller of the motion detection circuitry is configured to provide time-related gesture data on a second time scale larger than the first time scale.

28. The aerosol-generating device according to claim 22,
wherein the motion sensor controller of the motion detection circuitry is configured to determine at least one predefined gesture event in the gesture performed on the aerosol-generating device based on detecting at least one motion pattern associated with the at least one gesture event in the motion sensor data, and
wherein the motion sensor controller of the motion detection circuitry is further configured to provide at least one gesture data element indicative of the determined at least one gesture event to the device control circuitry.

29. The aerosol-generating device according to claim 22, wherein the motion sensor controller of the motion detection circuitry is configured to determine a sequence of a plurality of gesture events in the gesture performed on the aerosol-generating device and to provide a sequence of gesture data elements to the device control circuitry.

30. The aerosol-generating device according to claim 23, wherein the predefined gesture event is of one or more of: a predefined tilt of the aerosol-generating device with respect to one or more spatial directions, a predefined velocity of the aerosol-generating device in one or more spatial directions, a predefined acceleration of the aerosol-generating device in one or more spatial directions, a predefined translational movement of the aerosol-generating device along one or more spatial directions, a predefined acceleration about one or more axes of the aerosol-generating device, a predefined angular speed about one or more axes of the aerosol-generating device, a predefined rotational movement about one or more axes of the aerosol-generating device, a tap, a double-tap, a multi-tap, a shake, a double-shake, a multi-shake, and a predetermined period of inactivity.

31. The aerosol-generating device according to claim 23, wherein the one or more gesture data elements include one or more of a time information related to the gesture event, a start time of the gesture event, a stop time of the gesture event, and a duration of the gesture event.

32. The aerosol-generating device according to claim 22, wherein the device control circuitry is configured to determine the gesture based on one or more gesture data elements provided by the motion sensor controller of the motion detection circuitry.

33. The aerosol-generating device according to claim 22, wherein the device control circuitry is configured to determine the gesture based on one or more gesture data elements and based on a time period between at least two consecutive gesture data elements.

34. The aerosol-generating device according to claim 33, wherein the device control circuitry is configured to determine the gesture based on determining the time period between the at least two consecutive gesture data elements.

35. The aerosol-generating device according to claim 22, wherein the device control circuitry is configured to determine the gesture based on one or more of: a type of one or more gesture data elements, a sequence of a plurality of gesture data elements, a duration of one or more predefined gesture events associated with one or more gesture data elements, an occurrence of one or more gesture data elements within a predetermined period of time, a number of occurrences of gesture data elements within a predetermined period of time, a frequency of gesture data elements, and a time period between two consecutive gesture data elements.

36. The aerosol-generating device according to claim 22,
wherein the device control circuitry is configured to determine the gesture performed on the aerosol-generating device based on comparing at least a part of the gesture data to reference gesture data, and/or
wherein the device control circuitry is further configured to determine the gesture performed on the aerosol-generating device based on comparing one or more gesture data elements of the gesture data to one or more reference gesture data elements indicative of one or more predefined gesture events.

37. The aerosol-generating device according to claim 22, wherein the device control circuitry is configured to determine the at least one device function based on the determined gesture and/or based on one or more gesture data elements of the gesture data.

38. The aerosol-generating device according to claim 22, wherein the at least one device function includes one or more of: altering an operational mode of the aerosol-generating device, altering a power state of the aerosol-generating device, altering a configuration of the aerosol-generating device, altering a locked state of the aerosol-generating device, actuating a user interface of the aerosol-generating device, controlling a user interface of the aerosol-generating device to provide information to the user, controlling one or more settings of the aerosol-generating device, resetting the aerosol-generating device, controlling a heating element of the aerosol-generating device, controlling a heating element of an aerosol-generating article couplable to the aerosol-generating device to generate aerosol, and controlling a heating temperature of the aerosol-generating device.

39. An aerosol-generating system, comprising:
an aerosol-generating device according to claim 22; and
an aerosol-generating article couplable to the aerosol-generating device and/or a receiving device configured to at least partly receive the aerosol-generating device.

40. A method of operating an aerosol-generating device including motion detection circuitry with at least one motion sensor and a motion sensor controller, and including device control circuitry communicatively coupled to the motion detection circuitry, the method comprising:
processing, with the motion sensor controller of the motion detection circuitry, motion sensor data of the at least one motion sensor into gesture data indicative of a gesture performed on the aerosol-generating device by movement of the aerosol-generating device;
determining, based on analyzing the gesture data with the device control circuitry, the gesture performed on the aerosol-generating device; and
controlling, with the device control circuitry, the aerosol-generating device to perform at least one device function in response to the determined gesture.

41. The method according to claim 40,
wherein the motion sensor data includes raw sensor data generated by the motion sensor of the motion detection circuitry in response to sensing one or more of a motion, a positional change, a rotation, an orientational change, a rotational change, and an acceleration of the aerosol-generating device, and
wherein the processing of the motion sensor data includes computing the gesture data based on the motion sensor data.
